(19) United States
(12) Patent Application Publication
(10) Pub. No.: US 2014/0171593 A1
(43) Pub. Date: Jun. 19, 2014

(54) FLUORINATED BLOCK COPOLYMER AND PROCESS FOR ITS PRODUCTION, AND SURFACE TREATMENT AGENT

(71) Applicant: Asahi Glass Company, Limited, Chiyoda-ku (JP)

(72) Inventors: Takashi SASAKI, Tokyo (JP); Taiki Hoshino, Tokyo (JP); Miyako Sasaki, Tokyo (JP); Nobuyuki Otozawa, Tokyo (JP)

(73) Assignee: Asahi Glass Company, Limited, Chiyoda-ku (JP)

(21) Appl. No.: 14/187,974

(22) Filed: Feb. 24, 2014

Related U.S. Application Data
(63) Continuation of application No. PCT/JP12/70930, filed on Aug. 17, 2012.

(30) Foreign Application Priority Data
Aug. 24, 2011 (JP) 2011-182375

(51) Int. Cl. C08F 293/00

(52) U.S. Cl. CPC C08F 293/005
USPC 525/276

(57) ABSTRACT

A fluorinated block copolymer having R^{f} groups with at most 6 carbon atoms, and a surface treatment agent containing such a copolymer, whereby a coating film excellent in both static liquid repellency and dynamic liquid repellency can be formed. The fluorinated block copolymer comprises a fluorinated moiety (A) having units (a) derived from a specific fluorinated monomer and a non-fluorinated moiety (B) having units (b) derived from a non-fluorinated monomer, wherein to all units, the proportion of the above units (a) is from 15 to 40 mol %, and the proportion of the above units (b) is from 60 to 85 mol %; a process for its production; and a surface treatment agent containing the fluorinated block copolymer.

This application is a continuation of PCT Application No. PCT/JP2012/070930, filed on Aug. 17, 2012, which is based upon and claims the benefit of priority from Japanese Patent Application No. 2011-182375 filed on Aug. 24, 2011. The contents of those applications are incorporated herein by reference in its entirety.

### TECHNICAL FIELD

The present invention relates to a fluorinated block copolymer and a process for its production, and a surface treatment agent.

### BACKGROUND ART

A fluorinated polymer is used as a surface treatment agent such as a water and oil repellent. Such a surface treatment agent may be applied to a surface of an inorganic substrate (such as a metal or glass) or an organic substrate (such as a polycarbonate) to form a coating film, thereby to obtain an article having a water and oil repellency. As such a fluorinated polymer, a fluorinated polymer is known which has fluoroalkyl groups (hereinafter referred to as “R^{f} groups”) with at least 8 carbon atoms. However, a fluorinated polymer having R^{f} groups with at least 7 carbon atoms is worried about its high environmental load. Therefore, it is desired to use a fluorinated polymer having R^{f} groups with at most 6 carbon atoms and having no R^{f} groups with at least 7 carbon atoms.

As a fluorinated polymer having R^{f} groups with at most 6 carbon atoms, a fluorinated block copolymer is known which is obtainable by block-copolymerizing a (meth)acrylate type monomer having a perfluoroalkyl group (hereinafter referred to as a “R^{F} group”), such as CF₃(CF₂)₅(CH₂)₂OC(O)C(CH₃)═CH₂ (hereinafter referred to as “C6FMA”) with a non-fluorinated (meth)acrylate type monomer such as stearyl acrylate (Patent Document 1).

### PRIOR ART DOCUMENT

### Patent Document

Patent Document 1: JP-A-2009-242550

### DISCLOSURE OF INVENTION

### Technical Problem

However, as a result of a detailed study with respect to liquid repellency of the coating film formed by using the fluorinated block copolymer disclosed in Patent Document 1, it has been found that although excellent static liquid repellency (static water repellency and static oil repellency) is obtainable, it is difficult to obtain sufficient dynamic liquid repellency (dynamic water repellency and dynamic oil repellency).

It is an object of the present invention to provide a fluorinated block copolymer which has R^{f} groups with at most 6 carbon atoms and which is capable of forming a coating film having excellent static liquid repellency and dynamic liquid repellency, and a process for producing such a fluorinated block copolymer.

Further, it is another object of the present invention to provide a surface treatment agent which is capable of imparting excellent static liquid repellency and dynamic liquid repellency to an article.

### Solution to Problem

In order to solve the above problem, the present invention has adopted the following constructions.
[1] A fluorinated block copolymer comprising a fluorinated moiety (A) having units (a) derived from a monomer represented by the following formula (1) and a non-fluorinated moiety (B) having units (b) derived from a non-fluorinated monomer, of which a homopolymer would have a glass transition temperature of at least 30° C., wherein to all units, the proportion of the above units (a) is from 15 to 40 mol %, and the proportion of the above units (b) is from 60 to 85 mol %:

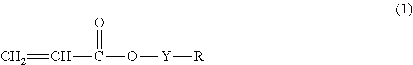

in the formula (1), Y is a C₁₋₄ aliphatic group, and R is a C₄₋₆ linear or branched R^{f} group.
[2] The fluorinated block copolymer according to [1], wherein Yin the formula (1) is an ethylene group.
[3] The fluorinated block copolymer according to [1] or [2], wherein R in the formula (1) is a C₆ R^{F} group.
[4] The fluorinated block copolymer according to [1], wherein the monomer represented by the formula (1) is 2-perfluorohexylethyl acrylate.
[5] The fluorinated block copolymer according to any one of [1] to [4], wherein the non-fluorinated monomer contains at least one member selected from the group consisting of a (meth)acrylate type monomer, an acrylamide type monomer, an aromatic hydrocarbon type vinyl monomer and a vinyl ether type monomer.
[6] The fluorinated block copolymer according to any one of [1] to [4], wherein the non-fluorinated monomer contains at least one member selected from the group consisting of methyl methacrylate, ethyl methacrylate, propyl methacrylate, a (meth)acrylamide, an N-methylol (meth)acrylamide, styrene and cyclohexyl vinyl ether.
[7] The fluorinated block copolymer according to any one of [1] to [4], wherein the non-fluorinated monomer is methyl methacrylate or ethyl methacrylate.
[8] A surface treatment agent containing a fluorinated block copolymer as defined in any one of [1] to [7].
[9] A process for producing a fluorinated block copolymer by a living radical polymerization method, which comprises a step (I) of polymerizing a non-fluorinated monomer in the presence of a RAFT agent to obtain a polymer (X), and a step (II) of polymerizing a monomer represented by the following formula (1) in the presence of the polymer (X) obtained in step (I) and a RAFT agent to obtain a fluorinated block copolymer, wherein to all monomers used for the polymerization, the proportion of the monomer represented by the following formula (1) is from 15 to 40 mol %, and the proportion of the non-fluorinated monomer is from 60 to 85 mol %:

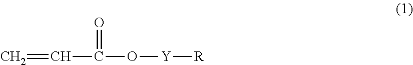

in the formula (1), Y is a C₁₋₄ aliphatic group, and R is a C₄₋₆ linear or branched R^{f} group.

### Advantageous Effects of Invention

The fluorinated block copolymer of the present invention has R^{f} groups with at most 6 carbon atoms, whereby it is capable of forming a coating film excellent in both static liquid repellency and dynamic liquid repellency.

Further, according to the process of the present invention, it is possible to produce a fluorinated block copolymer having R^{f} groups with at most 6 carbon atoms, whereby it is capable of forming a coating film excellent in both static liquid repellency and dynamic liquid repellency.

Further, the surface treatment agent of the present invention contains the fluorinated block copolymer of the present invention, whereby it is possible to impart excellent static liquid repellency and dynamic liquid repellency to an article.

### DESCRIPTION OF EMBODIMENTS

In this specification, methyl (meth)arylate means methyl acrylate or methyl methacrylate, and the same applies to other compounds.

### <Fluorinated Block Copolymer>

The fluorinated block copolymer of the present invention is a block copolymer which has a fluorinated moiety (A) having the after-described units (a) and a non-fluorinated moiety (B) having units (b) and which may further have another moiety (C) having units (c), as the case requires.

### [Fluorinated Moiety (A)]

The fluorinated moiety (A) is a block chain in which two or more units (a) derived from a monomer (hereinafter referred to as a “monomer (α)”) represented by the following formula (1) are chained.

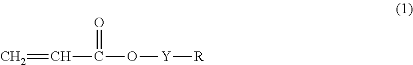

in the formula (1), Y is a C₁₋₄ aliphatic group, and R is a C₄₋₆ linear or branched R^{f} group.

The R^{f} group is a group having at least one hydrogen atom in an alkyl group substituted by a fluorine atom. The R^{f} group may be a R^{E} group having all hydrogen atoms in an alkyl group substituted by fluorine atoms, or a group having some of hydrogen atoms in an alkyl group substituted by fluorine atoms.

From the viewpoint of water and oil repellency, Y is preferably a C₁₋₄ alkylene group, particularly preferably an ethylene group.

From the viewpoint of water and oil repellency, R is preferably a C₄₋₆ R^{F} group, more preferably a C₆ R^{F} group. Specifically, —CF₂CF₂CF₂CF₃, —CF₂CF(CF₃)₂, —C(CF₃)₃, —(CF₂)₄CF₃, —(CF₂)₂CF(CF₃)₂, —CF₂C(CF₃)₃, —CF(CF₃)CF₂CF₂CF₃, —(CF₂)₅CF₃ or —(CF₂)₃CF(CF₃)₂ is preferred, —(CF₂)₅CF₃ or —(CF₂)₃CF(CF₃)₂ is more preferred, and —(CF₂)₅CF₃ is particularly preferred.

Specific examples of the monomer (α) include, for example, 2-perfluorohexylethyl acrylate (hereinafter referred to as “C6FA”), 2-perfluorobutylethyl acrylate, 3,3,4,4,5,5,6,7,7,7-decafluoro-6-(trifluoromethyl)heptyl acrylate, etc. Among them, C6FA or 3,3,4,4,5,5,6,7,7,7-decafluoro-6-(trifluoromethyl)heptyl acrylate is preferred, and C6FA is particularly preferred.

Units (a) which the fluorinated moiety (A) has, may be of one type, or of two or more types, preferably of one type.

### [Non-Fluorinated Moiety (B)]

The non-fluorinated moiety (B) is a block chain in which two or more units (b) derived from a non-fluorinated monomer (hereinafter referred to as a “non-fluorinated monomer β)”), of which a homopolymer would have a glass transition temperature (hereinafter referred to as “Tg”) of at least 30° C., are chained. The non-fluorinated monomer (β) is a monomer which is copolymerizable with the monomer (α) and has no fluorine atom in its molecule, and is a monomer, of which a homopolymer has a Tg of at least 30° C. From such a viewpoint that a coating film excellent in static water repellency and dynamic oil repellency is readily obtainable, the non-fluorinated monomer (β) is preferably a monomer, of which a homopolymer would have a Tg of from 50 to 300° C., more preferably a monomer, of which a homopolymer would have a Tg of from 60 to 250° C. If the Tg of such a homopolymer would be less than 30° C., no adequate dynamic water repellency tends to be obtainable, such being undesirable.

Here, the Tg of such a homopolymer is a Tg obtainable by a differential scanning calorimetry of a homopolymer having a number average molecular weight (Mn) of at least 10,000 obtained by polymerizing the non-fluorinated monomer (β).

The non-fluorinated monomer (β) is preferably at least one member selected from the group consisting of a (meth)acrylate type monomer, an acrylamide type monomer, an aromatic hydrocarbon type vinyl monomer and a vinyl ether type monomer.

The (meth)acrylate type monomer may, for example, be acrylic acid [Tg: 106° C.], methacrylic acid [Tg: 228° C.], methyl methacrylate (hereinafter referred to as “MMA”) [Tg: 105° C.], ethyl methacrylate [Tg: 65° C.], n-propyl methacrylate [Tg: 35° C.], isopropyl methacrylate [Tg: 81° C.], isobutyl methacrylate [Tg: 60° C.], t-butyl methacrylate [Tg: 118° C.], t-butyl acrylate [Tg: 73° C.], hexadecyl acrylate [Tg: 35° C.], behenyl acrylate [Tg: 86° C.], phenyl methacrylate [Tg: 110° C.], phenyl acrylate [Tg: 57° C.], isooctyl (meth)acrylate, isodecyl (meth)acrylate, cyclohexyl methacrylate [Tg: 83° C.], benzyl methacrylate [Tg: 54° C.], hydroxyethyl methacrylate [Tg: 55° C.], diethylene glycol mono(meth)acrylate, triethylene glycol mono(meth)acrylate, tetraethylene glycol mono(meth)acrylate, polyethylene glycol mono(meth)acrylate, hydroxypropyl methacrylate [Tg: 76° C.], dipropylene glycol mono(meth)acrylate, tripropylene glycol mono(meth)acrylate, tetrapropylene glycol mono(meth)acrylate, polypropylene glycol (meth)acrylate, glycidyl (meth)acrylate, dipropylaminoethyl (meth)acrylate, dibutylaminoethyl (meth)acrylate, 4-(meth)acryloyloxy-2,2,6,6-tetramethylpiperidine, 4-(meth)acryloylamino-2,2,6,6-tetramethylpiperidine, 4-(meth)acryloyloxy-1,2,2,6,6-pentamethylpiperidine, 4-(meth)acryloylamino-1,2,2,6,6-pentamethylpiperidine, 2-hydroxy-4-[2-(meth)acryloxyethoxy]benzophenone, 2-hydroxy-[3-(meth)acryloxy-2-hydroxypropoxy]benzophenone, 2,2′-dihydroxy-4-[3-(meth)acryloxy-2-hydroxypropoxy]benzophenone, a quaternary ammonium salt of diethylaminoethyl (meth)acrylate, or a quaternary ammonium salt derived from (meth)acrylic acid, such as 2-hydroxy-3-methacryloxypropyl ammonium chloride.

The acrylamide type monomer may, for example, be (meth)acrylamide [Tg: 165° C.] or N-methylol(meth)acrylamide.

The aromatic hydrocarbon type vinyl monomer may, for example, be styrene [Tg: 100° C.].

The vinyl ether type monomer may, for example, be t-butyl vinyl ether [Tg: 88° C.] or cyclohexyl vinyl ether [Tg: 81° C.].

The non-fluorinated monomer (β) is preferably at least one member selected from the group consisting of MMA, ethyl methacrylate, propyl methacrylate, (meth)acrylamide, N-methylol (meth)acrylamide, styrene and cyclohexyl vinyl ether, particularly preferably MMA or ethyl methacrylate, since it is excellent in the solubility in the after-mentioned polymerization solvent and the productivity.

Units (b) in the non-fluorinated moiety (B) may be of one type, or of two or more types.

### [Another Moiety (C)]

The fluorinated block copolymer of the present invention may have, in addition to the fluorinated moiety (A) and the non-fluorinated moiety (B), another moiety (C) having units (c) derived from a monomer other than the monomer (α) and the non-fluorinated monomer (β) to form units (b). Another moiety (C) may be one unit (c) or a block chain wherein two or more units (c) are chained. Another moiety (C) may be another fluorinated moiety (C1) having units (c1) derived from a fluorinated monomer other than the monomer (α), or another non-fluorinated moiety (C2) having units (c2) derived from a non-fluorinated monomer other than the non-fluorinated monomer (β) to form units (b).

Another fluorinated monomer may, for example, be 2-perfluorohexylethyl methacrylate (C6FMA) or 3,3,4,4,5,5,6,7,7,7-decafluoro-6-(trifluoromethyl)heptyl methacrylate.

Another non-fluorinated monomer may, for example, be methyl acrylate [Tg: 10° C.], ethyl acrylate [Tg: −50° C.], propyl acrylate [Tg: −37° C.], n-butyl acrylate [Tg: −54° C.], n-butyl methacrylate [Tg: 20° C.], pentyl methacrylate, hexyl methacrylate, heptyl methacrylate, octyl methacrylate, nonyl methacrylate, dodecyl (meth)acrylate, hexadecyl (meth)acrylate [Tg: 15° C.], octadecyl acrylate [Tg: −42° C.], 2-ethylhexyl methacrylate, 2-chloroethyl methacrylate or ethyl vinyl ether.

In a case where the fluorinated block copolymer of the present invention has another moiety (C), units (c) may be of one type, or of two or more types.

The proportion of units (a) to all units of the fluorinated block copolymer of the present invention is from 15 to 40 mol %. When the proportion of units (a) is at least 15 mol %, excellent water and oil repellency is obtainable. When the proportion of units (a) is at most 40 mol %, the water repellency will be maintained. The proportion of units (a) is preferably from 15 to 35 mol %, more preferably from 20 to 30 mol %.

The proportion of units (b) to all units of the fluorinated block copolymer of the present invention is from 60 to 85 mol %. When the proportion of units (b) is at least 60 mol %, the water and oil repellency, particularly oil repellency will be improved. When the proportion of units (b) is at most 85 mol %, the dynamic water repellency will be maintained. The proportion of units (b) is preferably from 65 to 85 mol %, more preferably from 70 to 80 mol %.

The proportion of units (c) to all units of the fluorinated block copolymer of the present invention is preferably from 0 to 25 mol %, more preferably from 0 to 20 mol %.

The fluorinated block copolymer of the present invention preferably comprises the fluorinated moiety (A) and the non-fluorinated moiety (B), and it is preferably a fluorinated block copolymer wherein units (a) are from 15 to 40 mol %, and units (b) are from 60 to 85 mol % (the total of units (a) and units (b) is 100 mol %), more preferably a fluorinated block copolymer wherein units (a) are from 20 to 30 mol %, and units (b) are from 70 to 80 mol % (the total of units (a) and units (b) is 100 mol %).

The fluorinated block copolymer of the present invention can be evaluated as it has two different glass transition temperatures i.e. a glass transition temperature (Tg¹) of from −20 to 40° C. attributable to the fluorinated moiety (A) and a glass transition temperature (Tg²) of at least 30° C. attributable to the non-fluorinated moiety (B).

The fluorinated block copolymer of the present invention may be a fluorinated block copolymer of any type such as an AB type, an ABA type or an ABAB type (where A represents the fluorinated moiety (A), and B represents the non-fluorinated moiety (B)), and an AB type fluorinated block copolymer is particularly preferred. In a case where the fluorinated block copolymer of the present invention contains another moiety (C), it is preferably a fluorinated block copolymer of an ABC type (where C represents another moiety (C)). As such another moiety (C), the above-mentioned another fluorinated moiety (C1) or the above-mentioned another non-fluorinated moiety (C2) may be used alone, or they may be used in combination.

The number average molecular weight (Mn) of the fluorinated block copolymer of the present invention is preferably from 5,000 to 100,000, more preferably from 10,000 to 50,000. When Mn of the fluorinated block copolymer is at least the lower limit value, excellent film-forming performance tends to be readily obtainable. When Mn of the fluorinated block copolymer is at most the upper limit value, excellent solubility in a solvent tends to be readily obtainable.

The ratio (Mw/Mn) of the weight average molecular weight (Mw) to Mn of the fluorinated block copolymer of the present invention is preferably from 1.0 to 3.0, more preferably from 1.3 to 1.7. When Mw/Mn of the fluorinated block copolymer is at least the lower limit value, the copolymer can be synthesized in good yield. When Mw/Mn of the fluorinated block copolymer is at most the upper limit value, the fluorinated moiety (A) and the non-fluorinated moiety (B) tend to be readily phase-separated at the time of the coating film formation, whereby excellent water and oil repellency tends to be readily obtainable.

Mn and Mw in the present invention are values calculated by gel permeation chromatography (GPC) under the following conditions. From the fact that the molecular weight distribution of a fluorinated block copolymer by GPC is “monodispersity” having one peak, it is evaluated to be a block copolymer.

Temperature for the measurement: 40° C.

Injected amount: 50 μL

Outlet velocity: 1 mL/min

Standard sample: EasiCal PM-2 (manufactured by Polymer Laboratories)

Eluent: Mixed solvent of dichloropentafluoropropane (AK-225)/hexafluoroisopropanol (HFIP)=99/1 (volume ratio)

### [Production Process]

The fluorinated block copolymer of the present invention may be obtained, for example, by a living radical polymerization method. Particularly, it is preferred to produce it by a RAFT polymerization (reversible addition-fragmentation chain transfer polymerization) using a RAFT agent, since the polymerization conditions are simple and the productivity is high. A process comprising the following steps (I) and (II) is particularly preferred.

(I) A step of polymerizing a non-fluorinated monomer (β) in the presence of a RAFT agent to obtain a polymer (X).

(II) A step of polymerizing a monomer (α) in the presence of the polymer (X) obtained in step (I) and a RAFT agent to obtain a fluorinated block copolymer.

The proportion of the monomer (α) to all monomers to be used for the polymerization is from 15 to 40 mol %, and the proportion of the non-fluorinated monomer is from 60 to 85 mol %.

### Step (I):

In the presence of a RAFT agent, a non-fluorinated monomer (β) is polymerized by a conventional radical polymerization method to obtain a polymer (X).

The RAFT agent may, for example, be cumyl dithiobenzoate (CDB) or 2-cyano-2-propyldodecyl trithiocarbonate.

The amount of the RAFT agent to be used is preferably from 0.1 to 10 parts by mass, more preferably from 0.5 to 2 parts by mass, per 100 parts by mass of the non-fluorinated monomer (β).

The radical polymerization initiator is preferably an azo type compound such as α,α′-azobisisobutyronitrile (AIBN).

The amount of the radical polymerization initiator to be used, is preferably from 0.01 to 2 parts by mass per 100 parts by mass of the non-fluorinated monomer (β).

The polymerization solvent may, for example, be toluene, metaxylene hexafluoride (mxHF) or dichloropentafluoropropane (AK-225).

The amount of the polymerization solvent to be used, is preferably from 0 (no solvent) to 200 parts by mass per 100 parts by mass of the non-fluorinated monomer (β).

The temperature for the polymerization is preferably from 40 to 100° C.

### Step (II):

In the presence of the polymer (X) obtained in step (I) and a RAFT agent, a monomer (α) is polymerized by a conventional radical polymerization method to obtain a fluorinated block copolymer.

In step (II), from the viewpoint of the productivity, it is advantageous to adopt a method of carrying out the polymerization by adding the monomer (α) to the reaction liquid containing the polymer (X) obtained in step (I) and a RAFT agent. Further, a radical polymerization initiator may be added as the case requires.

Otherwise, step (II) may be carried out by separating the polymer (X) from the reaction liquid obtained in step (I), followed by washing, drying, etc., as the case requires. In such a case, the polymer (X), a RAFT agent, a radical polymerization initiator and a polymerization solvent may be charged again.

The amount of the radical polymerization initiator to be used, is preferably from 0.01 to 2 parts by mass per 100 parts by mass of the polymer (α).

The amount of the polymerization solvent to be used, is preferably from 0 (no solvent) to 200 parts by mass per 100 parts by mass of the monomer (α).

The temperature for the polymerization is preferably from 40 to 100° C.

Further, in the process for producing a fluorinated block copolymer of the present invention, for example, in a case where a fluorinated block copolymer having another moiety (C) is to be produced, a step of polymerizing at least one member selected from the group consisting of another fluorinated monomer and another non-fluorinated monomer may be provided before step (I) or between steps (I) and (II). Further, instead of the RAFT polymerization, an atom transfer radical polymerization using an alkyl halide as one type of living radical polymerization, or a living radical polymerization via a nitroxide (i.e. NMP, nitroxide mediated polymerization) may be adopted.

The fluorinated block copolymer of the present invention as described above, has R^{f} groups with at most 6 carbon atoms and is capable of forming a coating film having both excellent static liquid repellency and dynamic liquid repellency. The reason as to why such effects are obtainable by the fluorinated block copolymer of the present invention is not necessarily clearly understood but is considered to be as follows. In the coating film formed by using the fluorinated block copolymer of the present invention, it is considered that the fluorinated moiety (A) and the non-fluorinated moiety (B) are phase-separated so that R^{f} groups of units (a) derived from the monomer (α) are concentrated at the surface of the coating film to reduce the surface energy, whereby excellent static liquid repellency is obtainable. Further, it is considered that the phase of the non-fluorinated moiety (B) formed by using a non-fluorinated monomer (β), of which a homopolymer has a high Tg, becomes harder than the phase of the fluorinated moiety (A), so that the motion of the R^{f} groups concentrated at the surface of the coating film is suppressed, whereby excellent dynamic liquid repellency is obtainable.

### <Surface Treatment Agent>

The surface treatment agent of the present invention is a composition which contains the fluorinated block copolymer of the present invention as an essential component and as the case requires, further contains a medium such as water or an organic solvent, a surfactant and additives. The surface treatment agent of the present invention may be used in an optional form such as a solution, an emulsion, an aerosol or the like.

One type of the fluorinated block copolymer of the present invention may be used alone, or two or more types thereof may be used in combination.

The medium may be water or an organic solvent.

The organic solvent may be a fluorinated organic solvent or a non-fluorinated organic solvent, and a fluorinated organic solvent is preferred from the viewpoint of non-flammability and since it is thereby possible to form a uniform coating film having a low surface tension and small surface thickness irregularities.

The fluorinated organic solvent may, for example, be dichloropentafluoropropane (AK-225, manufactured by Asahi Glass Company, Limited) or metaxylene hexafluoride (mxHF, manufactured by Tokyo Chemical Industry Co., Ltd.).

The non-fluorinated organic solvent may, for example, be acetone, toluene, tetrahydrofuran, chlorobenzene or the like.

One type of the organic solvent may be used alone, or two or more types thereof may be used in combination.

In a case where the surface treatment agent of the present invention contains water or an organic solvent, the content of the fluorinated block copolymer in the surface treatment agent (100 mass %) immediately after the production of the surface treatment agent is preferably from 20 to 40 mass %.

Further, at the time when the surface treatment agent of the present invention is to be applied to an article, the content of the fluorinated block copolymer in the surface treatment agent (100 mass %) is preferably from 0.2 to 5 mass %.

The surface treatment agent of the present invention preferably contains the fluorinated block copolymer and an aqueous medium. In this specification, an aqueous medium means a medium composed solely of water, or a medium which contains not more than 80 parts by mass of an organic solvent per 100 parts by mass of water.

The surfactant may be a hydrocarbon type surfactant or a fluorinated surfactant, each of which may be an anionic surfactant, a nonionic surfactant, a cationic surfactant or an amphoteric surfactant.

As the surfactant, from the viewpoint of dispersion stability, combined use of a nonionic surfactant and a cationic surfactant or an amphoteric surfactant, or single use of an anionic surfactant, is preferred, and combined use of a nonionic surfactant and a cationic surfactant is more preferred.

The content of the surfactant is preferably from 0 to 20 mass %, more preferably from 0 to 15 mass %, based on the surface treatment agent (100 mass %).

The additives include, for example, a penetrating agent, a defoaming agent, an absorbent, an antistatic agent, an antistatic polymer, an anticrease agent, a texture-adjusting agent, a film formation adjuvant, a water-soluble polymer (such as polyacrylamide or polyvinyl alcohol), a thermosetting agent (such as a melamine resin, an urethane resin, a triazine ring-containing compound or an isocyanate type compound), an epoxy curing agent (such as isophthalic acid dihydrazide, adipic acid dihydrazide, sebacic acid dihydrazide, dodecane diacid dihydrazide, 1,6-hexamethylenebis (N,N-dimethylsemicarbazide), 1,1,1′,1′-tetramethyl-4,4′-(methylene-di-para-phenylene)disemicarbazide or spiroglycol), a thermosetting catalyst, a cross-linking catalyst (such as an organic acid or ammonium chloride), a synthetic resin, a fiber-stabilizer, inorganic fine particles, etc.

Further, the surface treatment agent of the present invention may contain, as the case requires, a copolymer capable of providing water repellency and/or oil repellency other than the above-described fluorinated block copolymer (e.g. a commercially available water repellent, a commercially available oil repellent, a commercially available water and oil repellent, a commercially available SR agent, etc.) or a water repellent compound having no fluorine atoms. The water repellent compound having no fluorine atoms may, for example, be a paraffin type compound, an aliphatic amide type compound, an alkylethylene urea compound or a silicone type compound.

When applied to a substrate to form a coating film, the surface treatment agent of the present invention is capable of imparting excellent static liquid repellency and dynamic liquid repellency to the substrate. The substrate may, for example, be an inorganic substrate (such as a metal or glass), a resin substrate (such as polycarbonate) or a stone substrate.

As a method for applying the surface treatment agent of the present invention, a known method may be employed such as a roll coating method, a casting method, a dip coating method, a spin coating method or a spray coating method.

### EXAMPLES

Now, the present invention will be described in detail with reference to Examples, but it should be understood that the present invention is by no means restricted by the following description. Examples 3 to 5 are working Examples of the present invention, and Examples 1, 2 and 6 to 22 are comparative Examples.

[Raw Materials, etc]

Raw materials, etc. used in Examples are shown below.

### (Monomers)

C6FA: 2-Perfluorohexylethyl acrylate (one synthesized by a known method using 2-perfluorohexyl ethanol as the raw material, followed by simple distillation for purification)

C6FMA: 2-Perfluorohexylethyl methacrylate (one synthesized by a known method using 2-perfluorohexyl ethanol as the raw material, followed by simple distillation for purification)

MMA: Methyl methacrylate (one subjected to simple distillation for purification, manufactured by Kanto Chemical Co., Inc.)

### (Polymerization Initiators)

AIBN: α,α′-Azobisisobutyronitrile (one purified by a recrystallization method, manufactured by Kanto Chemical Co., Inc.) (RAFT agent)

CDB: Cumyl dithiobenzoate (one synthesized by the method disclosed at pages 48 to 49 of The 5th Edition, Experimental Chemistry Course, Polymer Chemistry, followed by purification)

### (Other Reagents)

Acetone, toluene, tetrahydrofuran, methanol and hexane (all manufactured by Kanto Chemical Co., Inc.); metaxylene hexafluoride (mxHF, manufactured by Tokyo Chemical Industry Co., Ltd.); dichloropentafluoropropane (AK-225, manufactured by Asahi Glass Company, Limited); and hexafluoroisopropanol (HFIP, manufactured by Central Glass Co., Ltd.)

### [Composition of Polymer]

The composition of a polymer recovered in each Example was measured by ¹H-NMR. The ratios (mol %) of C6FA units and MMA units were calculated by integral ratios of protons of C6FA units in the vicinity of 4.3 ppm and protons of MMA units in the vicinity of 3.6 ppm. Further, the ratios (mol %) of C6FMA units and MMA units were calculated by integral ratios of protons of C6FMA units in the vicinity of 4.3 ppm and protons of MMA units in the vicinity of 3.6 ppm.

### [Number Average Molecular Weight (Mn) and Weight Average Molecular Weight (Mw)]

In a mixed solvent of AK-225/HFIP=99/1 (volume ratio), a polymer recovered in each Example was dissolved to be 0.5 mass % and filtered through a filter with a pore diameter of 0.2 μm to obtain an analytical sample. With respect to the analytical sample, the number average molecular weight (Mn) and the weight average molecular weight (Mw) were measured by GPC under the following measurement conditions.

Apparatus: HLC-8220GPC (manufactured by TOSOH CORPORATION)

Column: One having two columns of MIXED-E (manufactured by Polymer Laboratories) connected in series.

Temperature for measurement: 40° C.

Injected amount: 50 μL

Outlet velocity: 1 mL/min

Standard sample: EasiCal PM-2 (manufactured by Polymer Laboratories)

Eluent: Mixed solvent of AK-225/HFIP=99/1 (volume ratio)

### [Glass Transition Temperature]

The glass transition temperature (Tg) of a polymer recovered in each Example was measured by differential scanning calorimetry (DSC method). Tg was read out from a curve at a heating rate of 10° C./min.

Apparatus: DSC Q100 (manufactured by TA Instruments)

Scanning temperature range: From −50° C. to 200° C.

Scanning rate: 10° C./min

Tg was measured twice with respect to the same sample, and the measured data of the second time was adopted.

### Examples 1 to 6

### Step (I):

Into a 25 mL pressure resistant glass ampule for polymerization, MMA as a non-fluorinated monomer (β), AIBN as a polymerization initiator, CDB as a RAFT agent and toluene as a solvent were charged in the charged amounts as shown in Table 1. Then, the mixed solution in the ampule was deaerated twice by a freeze deaeration method, and then, the ampule was closed and heated for 18 hours in an oil bath of 100° C. to obtain a reaction liquid containing a polymer (X1). After cooling the reaction liquid, the ampule was opened, and ¹H-NMR measurement of the reaction liquid was carried out to obtain the conversion by polymerization of MMA. The conversion by polymerization of MMA was at least 99% in each of Examples 1 to 6.

### Step (II):

To the reaction liquid in the ampule, C6FA as a monomer (α), AIBN as a polymerization initiator and a solvent were added in the composition as shown in Table 1, and after carrying out freeze deaeration twice, the ampule was closed and heated at 100° C. for 48 hours. Then, the polymerization solution was dropped into hexane of 20 times by mass, followed by stirring to precipitate solid. The obtained solid was collected by filtration and vacuum-dried at 40° C. overnight to obtain a block copolymer.

Each of block copolymers obtained in Examples 1 to 6 had a pink color and was soluble in acetone, toluene, tetrahydrofuran and AK-225.

TABLE 1

| | | | | | | | | Unit: g |
|---|---|---|---|---|---|---|---|---|
| | | | Ex.1 | Ex.2 | Ex.3 | Ex.4 | Ex.5 | Ex.6 |
| Step | Non-fluorinated | MMA | 2.92 | 2.66 | 1.51 | 1.54 | 1.14 | 1.07 |
| (I) | monomer (β) | | | | | | | |
| | RAFT agent | CDB | 0.03 | 0.03 | 0.03 | 0.03 | 0.03 | 0.03 |
| | Polymerization | AIBN | 0.007 | 0.009 | 0.009 | 0.007 | 0.007 | 0.007 |
| | initiator | | | | | | | |
| | Solvent | Toluene | 2.27 | 2.27 | 1.50 | 0.21 | 0.21 | 0.21 |
| Step | Monomer (α) | C6FA | 1.37 | 2.81 | 2.60 | 2.73 | 3.19 | 4.55 |
| (II) | Polymerization | AIBN | 0.003 | 0.003 | 0.003 | 0.003 | 0.003 | 0.003 |
| | initiator | | | | | | | |
| | Solvent | Toluene | 1.3 | 2.3 | 2.3 | 2.3 | 3.3 | 2.3 |
| | | mxHF | — | — | — | — | — | 2.3 |

### [Evaluation Methods]

### (Static Water Repellency)

A polymer obtained in each Example was dissolved in AK-225 to be 5 mass % thereby to prepare a surface treatment agent. The surface treatment agent was applied onto a silicon wafer by a spin coating method to form a coating film (thickness: about 100 nm) and then heat-treated at 150° C. for one hour to obtain a coating film sample. On the coating film of the obtained coating film sample, 2 μL of water was dropped, whereupon the contact angle was measured by means of dropmaster 700 (manufactured by Kyowa Interface Science Co., Ltd).

### (Static Oil Repellency)

The contact angle was measured in the same manner as in the evaluation of the static water repellency, except that instead of water, hexadecane was used.

### (Dynamic Water Repellency)

After obtaining a coating film sample in the same manner as in the evaluation of the static water repellency, 10 μL of water was dropped on the coating film of the coating film sample, and the coating film sample was inclined to an inclination angle of 50°, whereby the advance angle of the water droplet (the contact angle on the lower side of the droplet immediately prior to sliding down) and the sweepback angle (the contact angle on the upper side of the droplet immediately before sliding down) were measured.

Further, after dipping the coating film sample in distilled water at 40° C. for 3 hours, the advance angle and the sweepback angle were measured in the same manner.

Measured results of the compositions, Mn, Mw/Mn and Tg, and evaluation results of the liquid repellency, of the block copolymers obtained in Examples 1 to 6, are shown in Table 2. Here, in Table 2, “−4/120” for Tg in Example 2 means that there were two Tg's at −4° C. and at 120° C., and the same applies to other Examples. Further, “x” for dynamic water repellency means that the water droplet on the coating film sample did not slide down at an inclination angle of 50°.

TABLE 2

| | | | Ex. 1 | Ex. 2 | Ex. 3 | Ex. 4 | Ex. 5 | Ex. 6 |
|---|---|---|---|---|---|---|---|---|
| Block | Yield [g] | | 3.14 | 4.22 | 3.34 | 3.23 | 2.96 | 4.46 |
| copolymer | Composition | MMA units | 94 | 87 | 83 | 78 | 69 | 55 |
| | [mol %] | C6FA units | 6 | 13 | 17 | 22 | 31 | 45 |
| | Molecular | Mn | 20700 | 21000 | 19000 | 20900 | 19900 | 21500 |
| | weight | Mw/Mn | 1.5 | 1.5 | 1.4 | 1.3 | 1.3 | 1.4 |
| | Tg [° C.] | | 115 | −4/120 | −3/119 | −6/119 | −6/117 | −7/118 |
| Static water | Contact angle | | 104 | 110 | 109 | 111 | 111 | 125 |
| repellency | (water) [°] | | | | | | | |
| Static oil | Contact angle | | 65 | 77 | 77 | 77 | 77 | 79 |
| repellency | (hexadecane) [°] | | | | | | | |
| Dynamic | Initial | Advance | x | 122 | 120 | 120 | 120 | x |
| water | stage | angle [°] | | | | | | |
| repellency | | Sweepback | x | 76 | 93 | 87 | 89 | x |
| | | angle [°] | | | | | | |
| | After | Advance | x | x | 119 | 122 | 122 | x |
| | dipping | angle [°] | | | | | | |
| | | Sweepback | x | x | 86 | 85 | 89 | x |
| | | angle [°] | | | | | | |

As shown in Table 2, in Examples 3 to 5 wherein block copolymers of the present invention were used, coating films had excellent dynamic water repellency in addition to excellent static water repellency and static oil repellency. On the other hand, in Examples 1, 2 and 6 wherein block copolymers with proportions of units derived from the non-fluorinated monomer (α) and units derived from the monomer (β) being outside the ranges of the present invention, were used, coating films did not have sufficient dynamic water repellency.

### Examples 7 to 13

Into a 25 mL pressure resistant glass ampule for polymerization, MMA as a non-fluorinated monomer (β), C6FA as a monomer (α), AIBN as a polymerization initiator, CDB as a RAFT agent and toluene as a solvent were charged in the charged amounts as shown in Table 3. The mixed solution in the ampule was deaerated twice by a freeze deaeration method, and then, the ampule was closed and heated for 24 hours in an oil bath of 100° C. The polymerization solution was dropped into hexane of 20 times by mass, followed by stirring to precipitate solid. The obtained solid was collected by filtration and vacuum-dried at 40° C. overnight to obtain a random copolymer having a mass as shown in Table 4. In Examples 7 and 13, homopolymers were obtained.

Each of polymers obtained had a pink color and was soluble in acetone, toluene, tetrahydrofuran and AK-225.

Measured results of the compositions, Mn, Mw/Mn and Tg, and evaluation results of the liquid repellency, of the polymers obtained in Examples 7 to 13, are shown in Table 4.

TABLE 3

| | | | | | | | | Unit: g |
|---|---|---|---|---|---|---|---|---|
| | | Ex. 7 | Ex. 8 | Ex. 9 | Ex. 10 | Ex. 11 | Ex. 12 | Ex. 13 |
| Non-fluorinated | MMA | 4.03 | 2.92 | 1.44 | 1.26 | 0.54 | 0.32 | 0 |
| monomer (β) | | | | | | | | |
| Monomer (α) | C6FA | 0 | 1.37 | 1.52 | 2.28 | 2.28 | 3.19 | 4.56 |
| RAFT agent | CDB | 0.03 | 0.03 | 0.05 | 0.05 | 0.03 | 0.03 | 0.03 |
| Polymerization | AIBN | 0.011 | 0.007 | 0.015 | 0.015 | 0.009 | 0.009 | 0.009 |
| initiator | | | | | | | | |
| Solvent | Toluene | 1.70 | 2.39 | 0.87 | 0.88 | 0.88 | 1.30 | 0.87 |

TABLE 4

| | | | Ex. 7 | Ex. 8 | Ex. 9 | Ex. 10 | Ex. 11 | Ex. 12 | Ex. 13 |
|---|---|---|---|---|---|---|---|---|---|
| Random | Yield [g] | | 3.61 | 3.39 | 2.50 | 2.46 | 1.87 | 2.37 | 3.39 |
| copolymer | Composition | MMA units | 100 | 94 | 83 | 75 | 55 | 65 | 0 |
| (polymer) | [mol %] | C6FA units | 0 | 6 | 17 | 25 | 45 | 35 | 100 |
| | Molecular | Mn | 23000 | 23000 | 18000 | 18500 | 17000 | 17000 | 22000 |
| | weight | Mw/Mn | 1.4 | 1.4 | 1.3 | 1.5 | 1.4 | 1.5 | 1.2 |
| | Tg [° C.] | | 112 | 84 | 57 | 46 | 18 | 3 | −7 |
| Static water | Contact angle | | 67 | 98 | 104 | 107 | 109 | 125 | 129 |
| repellency | (water) [°] | | | | | | | | |
| Static oil | Contact angle | | 9 | 55 | 67 | 68 | 72 | 79 | 97 |
| repellency | (hexadecane) [°] | | | | | | | | |
| Dynamic | Initial | Advance | 74 | 104 | x | x | x | x | x |
| water | stage | angle [°] | | | | | | | |
| repellency | | Sweepback | 59 | 61 | x | x | x | x | x |
| | | angle [°] | | | | | | | |
| | After | Advance | 74 | 95 | x | x | x | x | x |
| | dipping | angle [°] | | | | | | | |
| | | Sweepback | 49 | 55 | x | x | x | x | x |
| | | angle [°] | | | | | | | |

As shown in Table 4, in Examples 8 to 12 wherein random copolymers were used, the coating films did not have sufficient dynamic water repellency. Further, the coating films in Examples 8 to 12 were inferior in static water repellency and static oil repellency as compared with the coating films in Examples 2 to 6 wherein block copolymers having the same levels of proportions of units derived from the non-fluorinated monomer (β) and units derived from the monomer (α) were used.

In Example 7 wherein a homopolymer of MMA was used, all of the static water repellency, static oil repellency and dynamic water repellency were inferior. In Example 13 wherein a homopolymer of C6FA was used, no adequate dynamic water repellency was obtainable, although excellent static water repellency and static oil repellency were obtained.

### Examples 14 to 18

Block copolymers were obtained in the same manner as in Examples 1 to 6 except that instead of C6FA, C6FMA was used, and the charged amount of each component was changed as shown in Table 5. The conversion by polymerization of MMA in each of Examples 14 to 18 was at least 99%. Further, the obtained block copolymers had a pink color and were soluble in acetone, toluene, tetrahydrofuran and AK-225.

Measured results of the compositions, Mn, Mw/Mn and Tg, and evaluation results of the liquid repellency, of the block copolymers obtained in Examples 14 to 18, are shown in Table 6. Here, the evaluation of the liquid repellency was carried out in the same manner as the evaluation of the liquid repellency in Examples 1 to 6, except that instead of a silicon wafer, a glass substrate was used.

TABLE 5

| | | | | | | | Unit: g |
|---|---|---|---|---|---|---|---|
| | | | Ex. 14 | Ex. 15 | Ex. 16 | Ex. 17 | Ex. 18 |
| Step | Non-fluorinated | MMA | 3.59 | 2.66 | 1.86 | 1.40 | 1.06 |
| (I) | monomer (β) | | | | | | |
| | RAFT agent | CDB | 0.03 | 0.03 | 0.03 | 0.03 | 0.03 |
| | Polymerization | AIBN | 0.009 | 0.009 | 0.009 | 0.009 | 0.009 |
| | initiator | | | | | | |
| | Solvent | Toluene | 2.29 | 2.30 | 2.21 | 2.39 | 2.68 |
| Step | Another | C6FMA | 1.74 | 2.89 | 3.48 | 3.93 | 4.64 |
| (II) | monomer | | | | | | |
| | Polymerization | AIBN | 0.003 | 0.003 | 0.003 | 0.003 | 0.003 |
| | initiator | | | | | | |
| | Solvent | mxHF | 3.51 | 3.49 | 3.54 | 3.49 | 3.51 |

TABLE 6

| | | | Ex. 14 | Ex. 15 | Ex. 16 | Ex. 17 | Ex. 18 |
|---|---|---|---|---|---|---|---|
| Block | Yield [g] | | 4.77 | 4.67 | 4.51 | 4.37 | 4.54 |
| copolymer | Composition | MMA units | 92 | 85 | 81 | 72 | 60 |
| | [mol %] | C6FMA units | 8 | 15 | 19 | 28 | 40 |
| | Molecular | Mn | 27000 | 23000 | 19500 | 19000 | 27000 |
| | weight | Mw/Mn | 1.2 | 1.2 | 1.4 | 1.3 | 1.3 |
| | Tg [° C.] | | 115 | 115 | 16/114 | 29/111 | 30/114 |
| Static water | Contact angle | | 116 | 117 | 117 | 116 | 117 |
| repellency | (water) [°] | | | | | | |
| Static oil | Contact angle | | 74 | 74 | 75 | 75 | 77 |
| repellency | (hexadecane) [°] | | | | | | |
| Dynamic | Initial | Advance | x | x | 120 | 121 | 121 |
| water | stage | angle [°] | | | | | |
| repellency | | Sweepback | x | x | 73 | 73 | 76 |
| | | angle [°] | | | | | |
| | After | Advance | x | x | x | x | x |
| | dipping | angle [°] | | | | | |
| | | Sweepback | x | x | x | x | x |
| | | angle [°] | | | | | |

As shown in Table 6, in Examples 14 to 18 wherein block copolymers were used in which instead of C6FA, C6FMA which is not a monomer (α) was used, the coating films did not have adequate dynamic water repellency.

### Examples 19 to 22

Random copolymers were obtained in the same manner as in Examples 1 to 6 except that instead of C6FA, C6FMA was used, and the charged amount of each component was changed as shown in Table 7. In Example 22, a homopolymer was obtained.

The obtained polymers had a pink color and were soluble in acetone, toluene, tetrahydrofuran and AK-225.

Measured results of the compositions, Mn, Mw/Mn and Tg, and evaluation results of the liquid repellency, of the polymers obtained in Examples 19 to 22, are shown in Table 8. Here, the evaluation of the liquid repellency was carried out in the same manner as the evaluation of the liquid repellency in Examples 1 to 6, except that instead of a silicon wafer, a glass substrate was used.

TABLE 7
Unit: g

| | | Ex. 19 | Ex. 20 | Ex. 21 | Ex. 22 |
|---|---|---|---|---|---|
| Non- | MMA | 3.59 | 2.66 | 1.86 | 0.00 |
| fluorinated | | | | | |
| monomer (β) | | | | | |
| Another | C6FMA | 1.74 | 2.89 | 3.48 | 5.80 |
| monomer | | | | | |
| RAFT agent | CDB | 0.03 | 0.03 | 0.03 | 0.03 |
| Polymerization | AIBN | 0.009 | 0.009 | 0.009 | 0.009 |
| initiator | | | | | |
| Solvent | Toluene | 2.15 | 2.17 | 2.18 | 2.11 |
| | mxHF | 3.50 | 3.50 | 3.50 | 3.50 |

TABLE 8

| | | | Ex. 19 | Ex. 20 | Ex. 21 | Ex. 22 |
|---|---|---|---|---|---|---|
| Random | Yield [g] | | 4.96 | 4.93 | 4.52 | 5.43 |
| copolymer | Composition | MMA units | 94 | 82 | 70 | 0 |
| (polymer) | [mol %] | C6FMA units | 6 | 18 | 30 | 100 |
| | Molecular | Mn | 25000 | 24000 | 22500 | 20800 |
| | weight | Mw/Mn | 1.3 | 1.2 | 1.2 | 1.1 |
| | Tg [° C.] | | 94 | 78 | 65 | 25 |
| Static water | Contact angle | | 99 | 105 | 109 | 118 |
| repellency | (water) [°] | | | | | |
| Static oil | Contact angle | | 54 | 62 | 66 | 77 |
| repellency | (hexadecane) [°] | | | | | |
| Dynamic | Initial | Advance | 105 | 109 | 112 | 122 |
| water | stage | angle [°] | | | | |
| repellency | | Sweepback | 76 | 78 | 78 | 74 |
| | | angle [°] | | | | |
| | After | Advance | x | x | x | 119 |
| | dipping | angle [°] | | | | |
| | | Sweepback | x | x | x | 70 |
| | | angle [°] | | | | |

As shown in Table 8, in Examples 19 to 21 wherein random copolymers were used in which instead of C6FA, C6FMA which is not a monomer (α) was used, the coating films did not have adequate dynamic water repellency. Further, in Example 22 in which a homopolymer of C6FMA was used, the dynamic water repellency was deteriorated after the dipping.

### INDUSTRIAL APPLICABILITY

The fluorinated block copolymer of the present invention is useful for the production of a surface treatment agent which is capable of imparting excellent static liquid repellency and dynamic liquid repellency to an article.

What is claimed is:

1. A fluorinated block copolymer comprising a fluorinated moiety (A) having units (a) derived from a monomer represented by the following formula (1) and a non-fluorinated moiety (B) having units (b) derived from a non-fluorinated monomer, of which a homopolymer would have a glass transition temperature of at least 30° C., wherein to all units, the proportion of the above units (a) is from 15 to 40 mol %, and the proportion of the above units (b) is from 60 to 85 mol %: 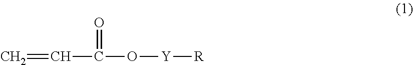
in the formula (1), Y is a C₁₋₄ aliphatic group, and R is a C₄₋₆ linear or branched fluoroalkyl group.

2. The fluorinated block copolymer according to claim 1, wherein Y in the formula (1) is an ethylene group.

3. The fluorinated block copolymer according to claim 1, wherein R in the formula (1) is a C₆ perfluoroalkyl group.

4. The fluorinated block copolymer according to claim 1, wherein the monomer represented by the formula (1) is 2-perfluorohexylethyl acrylate.

5. The fluorinated block copolymer according to claim 1, wherein the non-fluorinated monomer contains at least one member selected from the group consisting of a (meth)acrylate type monomer, an acrylamide type monomer, an aromatic hydrocarbon type vinyl monomer and a vinyl ether type monomer.

6. The fluorinated block copolymer according to claim 1, wherein the non-fluorinated monomer contains at least one member selected from the group consisting of methyl methacrylate, ethyl methacrylate, propyl methacrylate, a (meth)acrylamide, an N-methylol (meth)acrylamide, styrene and cyclohexyl vinyl ether.

7. The fluorinated block copolymer according to claim 1, wherein the non-fluorinated monomer is methyl methacrylate or ethyl methacrylate.

8. A surface treatment agent containing a fluorinated block copolymer as defined in claim 1.

9. A process for producing a fluorinated block copolymer by a living radical polymerization method, which comprises a step (I) of polymerizing a non-fluorinated monomer in the presence of a RAFT agent to obtain a polymer (X), and a step (II) of polymerizing a monomer represented by the following formula (1) in the presence of the polymer (X) obtained in step (I) and a RAFT agent to obtain a fluorinated block copolymer, wherein to all monomers used for the polymerization, the proportion of the monomer represented by the following formula (1) is from 15 to 40 mol %, and the proportion of the non-fluorinated monomer is from 60 to 85 mol %: 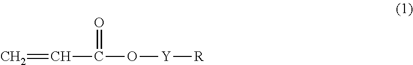
in the formula (1), Y is a C₁₋₄ aliphatic group, and R is a C₄₋₆ linear or branched fluoroalkyl group.
